(19) United States
(12) Patent Application Publication
(10) Pub. No.: US 2010/0021257 A1
(43) Pub. Date: Jan. 28, 2010

(54) Method and Apparatus for Transferring Freight

(76) Inventors: Stephen Allen Hall, Plainfield, IN (US); Thomas Walker, Pendleton, IN (US)

Correspondence Address: BOSE MCKINNEY & EVANS LLP, 111 MONUMENT CIRCLE, SUITE 2700, INDIANAPOLIS, IN, 46204, US

(21) Appl. No.: 12/180,926

(22) Filed: Jul. 28, 2008

(51) Int. Cl. B60P 1/64; B65G 67/04

(52) U.S. Cl. 410/46; 414/809

(57) ABSTRACT

A method of transferring freight from a first location to a second location. The method comprises the steps of loading the freight onto a plate at the first location, the plate having an identifier linked to the freight, monitoring the movement of the plate using the identifier on the loaded plate, conveying the loaded plate onto a first transportation unit at the first location, transporting the loaded plate from the first location to an interim location using the first transportation unit, conveying the loaded plate from the first transportation unit onto a second transportation unit, transporting the loaded plate from the interim location to the second location using the second transportation unit, conveying the loaded plate from the second transportation unit at the second location, and unloading the freight from the plate.

### TECHNICAL FIELD OF THE DISCLOSURE

The present invention generally relates to transferring freight, more particularly, to a method for bidirectional transfer of freight between a train car and a truck, between one truck to another truck, and between a truck and a holding facility.

### BACKGROUND OF THE DISCLOSURE

The freight hauling industry has become an important component of industrial growth of the U.S. and other industrialized nations. As articles of manufacture are imported, exported, and transferred from one location to another, these articles enter the freight hauling system and are processed on ships, train cars, semi-tractor trailers, smaller trucks and local facility hauling vehicles.

Traditionally, when a locomotive coupled to a series of cars arrives at a freight train station, some cars may need to be disengaged from other cars and connected to other locomotives. This is necessitated by the network of freight trains that travel thought out the country. For example, at a manufacturer, freight is loaded on to a train car in one corner of the country. The train car is connected to a locomotive that is destined for travel to a remote location. It is likely that the train car carrying the freight will have to be disengaged from the original locomotive and coupled train cars and attached to other locomotives several times before reaching the desired destination. However, disengagement of a train car from the locomotive and other train cars requires a complicated and time consuming procedure. When the train, made up of one or two locomotives and a series of train cars attached thereto, arrives at a switching station, i.e., a train yard designed to allow switching of train cars to and from locomotives and other train cars, several operations are required. First, the locomotive(s) is disengaged from the train cars. The train cars coupled together are pushed over a slight incline on the track, commonly referred to as a hump. As each train car is then disengaged from the remaining series of train cars, the disengaged train car is allowed to free-roll by gravity. Meanwhile switching station attendant directs the separated car on to a different track by switching the tracks. This process is repeated until the desired train car is disengaged and separated on to a temporary track. The desired train car is continually moved from track to track until it arrives to the appropriate track and is engaged with the correct locomotive.

This time consuming and cumbersome procedure is further complicated when the train finally arrives at the destination switching yard and needs to be unloaded. Large freight and load handling vehicles are needed to unload the train cars on to off-road and on-road freight transfer vehicles. Freight and loading handling vehicles are costly and often require maintenance. Additionally, for safety reasons the unloading operation is time consuming. These off/on-road vehicles in turn transfer the freight to the final destination. The freight transfer vehicles again have to be unloaded and the load transferred to a temporary floor space, e.g., a warehouse, by expensive load handling equipment. Finally the freight is separated into smaller loads and these are transferred to the appropriate floor space by smaller freight and load handling vehicle, e.g., smaller fork lifts.

The freight transfer process that exists today, which is described above, has inefficiencies at several points in the process, e.g., down time required for transferring a train car from one locomotive to another or transferring freight from train cars to freight handling vehicles; as well there exist a need for costly freight and load handling vehicles which require costly maintenance. Also, floor space is required to temporarily store freight at the destination location in order to disseminate the freight to appropriate locations at the destination. As well, the switching stations require hundreds of temporary tracks for the purpose of separating train cars from locomotives.

Due to the inefficiencies of the train switching yards, many freight hauling companies have switched to using only on-road freight hauling vehicles, e.g., semi-tractor vehicles. This new business model has caused many disadvantages. These disadvantages include a significant increased demand on the highway system, requiring wider roads, more frequent road maintenance, more traffic on the road with a significantly higher rate of accidents, idle trucks due to the need for a large truck inventory to handle peak demand, damaged freight from mishandling, longer overall freight shipment time, and increased fuel consumption (because many semi-tractor trailers are needed to haul the load of a fully loaded train. Another inefficiency realized in cases where long-haul trucking has been substituted for hauling freight by train networks is the number of hours that truck drivers have to be on the road for hauling a single load. Due to regulations, however, truck drivers are required to rest for several consecutive hours between driving periods. Although this requirement is necessary for safety reasons, it is an additional inefficiency resulting from long-haul trucking.

Therefore, there is a need for a new method of handling and transferring freight to address the above shortcomings and inefficiencies.

### SUMMARY OF THE INVENTION

The present teachings provide methods and systems for transferring freight.

In one form thereof, a method of transferring freight from a first location to a second location is provided. This method comprises the steps of loading the freight onto a plate at the first location, the plate having an identifier linked to the freight, monitoring the movement of the plate using the identifier on the loaded plate, conveying the loaded plate onto a first transportation unit at the first location, transporting the loaded plate from the first location to an interim location using the first transportation unit, conveying the loaded plate from the first transportation unit onto a second transportation unit, transporting the loaded plate from the interim location to the second location using the second transportation unit, conveying the loaded plate from the second transportation unit at the second location, and unloading the freight from the plate.

In another form thereof, a freight transfer system is provided. The freight transferring system comprises a platform for receiving a load from a first transportation unit, a conveyor on the platform for conveying the load from the first transportation unit on a first side of the platform to a second transportation unit on a second side of the platform, a plate carrying the load on the conveyor and in the first and the second transportation units, the plate having a readable identifier linked to the load, and a controller for monitoring the movement of the load using the identifier on the plate.

### BRIEF DESCRIPTION OF DRAWINGS

The above-mentioned and other advantages of the present invention and the manner of obtaining them will become more apparent and the invention itself will be better understood by reference to the following description of the embodiments of the invention taken in conjunction with the accompanying drawings, wherein:

FIG. 1 is a schematic of connectivity between different localities showing truck delivery areas, freight transfer yards, and railroad tracks;

FIG. 2 is a schematic showing a high traffic volume configuration of a freight transfer yard with dedicated direction train tracks;

FIG. 3 is a schematic showing a bi-directional traffic configuration of a freight transfer yard;

FIG. 4 is a schematic showing a freight transfer yard with an individual bypass run;

FIG. 5 is a schematic showing truck entrance and exit of the freight transfer yard of FIG. 4, in greater detail;

FIG. 6 is a schematic showing load and unload zone of the freight transfer yard of FIG. 5, in greater detail;

FIG. 7 is a schematic showing a greater detail of load and unload zones of the freight transfer yard of FIG. 6, including truck parking areas, truck load and unload conveyors, and train load and unload conveyors;

FIG. 8 is a schematic showing freight-carrying trucks arriving at the load and unload zones shown in FIGS. 7 and 8;

FIG. 9 is a schematic showing transfers of truck freight from the trucks on to the conveyors shown in FIG. 7;

FIG. 10 is a schematic showing transfer of freight from truck load and unload conveyors to train load conveyors shown in FIG. 7;

FIG. 11 is a schematic showing arrival of a train whereby the train's cars are congruently positioned with the train load conveyors;

FIG. 12 is a schematic showing transfer of freight from the train load conveyors to train cars;

FIG. 13 is a schematic showing arrival of a freight-carrying train congruently positioned with the train unload conveyors and with empty trucks positioned by truck load and unload conveyors;

FIG. 14 is a schematic showing freight being transferred from the train cars to train unload conveyors;

FIG. 15 is a schematic showing movement of freight transfer from train unload conveyors to truck load and unload conveyors and on to trucks;

FIG. 16 is a schematic showing arrival of a freight-carrying train to unload freight to and load freight from already unloaded freight carrying trucks;

FIG. 17 is a schematic showing transfer of freight from train cars on to train unload conveyors and transfer of freight from train load conveyors to train cars;

FIG. 18 is a schematic showing movement of freight, remaining from a departed train to unload conveyors and to freight accepting trucks;

FIG. 19 is a schematic showing loaded trucks leaving the load and unload zones;

FIGS. 20A-D are different views of an example of an adaptor plate;

FIGS. 21A-C are different views showing different locking mechanisms attached to the adaptor plate;

FIGS. 22A-D show different views of an example of stacking feature attached to the corners of the adaptor plate;

FIGS. 23A-B show an example of a coupling mechanism for connecting train cars to each other; and

FIGS. 24A-C show an example of a train car stabilization mechanism for stabilizing a train car during load and unloading operation.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

According to the current teachings, methods and systems involved in freight transfer may be altered in substantial ways. Transfer of freight from ships to train yards, from one train yard to another train yard, from trains to trucks, from trucks to trains, from train yards to temporary holding facilities, and from temporary holding facilities to final destination may benefit from the current teachings, as described below. The current teachings are a departure from the existing processes utilized in freight transfer. The teachings address some or all of the shortcomings of the existing freight transfer processes.

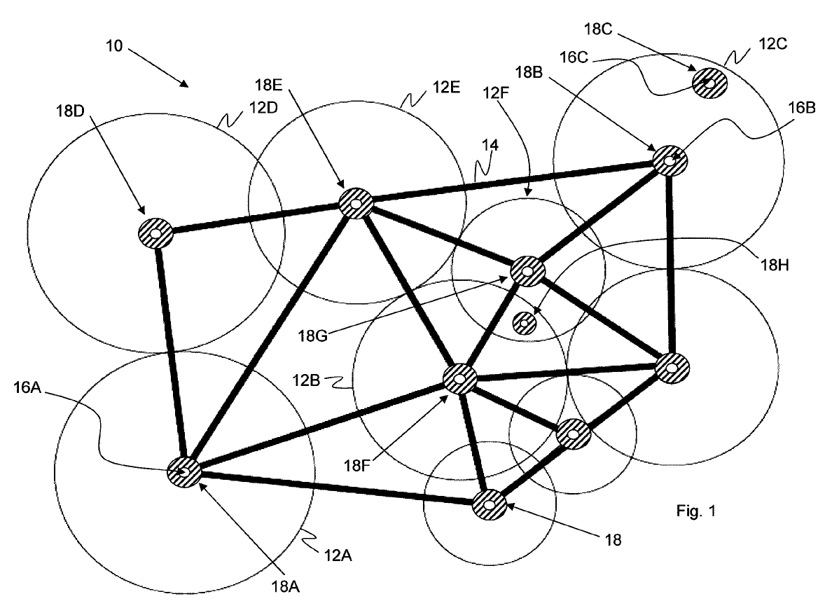

Referring to FIG. 1, a simplified freight transfer process, made possible by the current teachings, is shown. A network 10 of cities interconnected by a rail system is shown. Each city is shown by a crosshatched circle 18. Also shown in FIG. 1 are freight transfer yards 16. For example, three freight transfer yards are centrally located within cities 18A, 18B, and 18C. These freight transfer yards are designated with reference numerals 16A, 16B and 16C. Although each city is shown having one freight transfer yard 16, each city may have multiple transfer yards depending on the location and size of the city. For example, a centrally located city in a region of a country may be a hub and, therefore, the hub-city has more than one freight transfer yard. The cities and freight transfer yards are connected by a network of rail tracks 14. In FIG. 1, each city, and the freight transfer yard therein, is connected to another city by rail track 14, with the exception of 18C. In the case of city 18C, for example, the city or town is too remote for rail connectivity. Also, shown in FIG. 1 are truck delivery areas 12. Some of the truck delivery areas are overlapping or at least touch one another while others are not. Although truck delivery areas 12 are shown by circular patterns, these can be any shape that makes sense for the amount of traffic emanating from each city outward. For example, if large industrial complexes are concentrated on one side of a city, the truck delivery area associated with that city may be more of a pear-shape zone than circular. Similarly, the truck delivery areas may be entirely irregular in shape.

In network 10, freight transfer yards 16A and 16C are the farthest apart from each other. Freight traffic from cites 18A to 18C can take the route of 18A to 18F, to 18G, to 18B, all by rail, and from 18B to 18C by truck with a truck delivery area 12C. Alternatively, the traffic from 18A to 18C can take the route of 18A to 18D, to 18E, to 18B, all by rail, and from 18B to 18C by way of truck.

Where there are large overlaps in truck delivery areas, freight traffic decisions may depend on several factors. For example, truck delivery areas 12B and 12F have a large overlapping area. Freight traffic to city 18H, can take the route of 18F to 18G by rail and to 18H by truck within truck delivery area 12F. Conversely, the rail traffic may terminate at the city 18F and switch to truck within truck delivery area 12B. The decision as to which of the above combination of rail and truck routes is the most beneficial route depends on many factors. These include but not limited to delivery time, level of traffic within areas 12B and 12F, and availability of truck and rail within the affected zones.

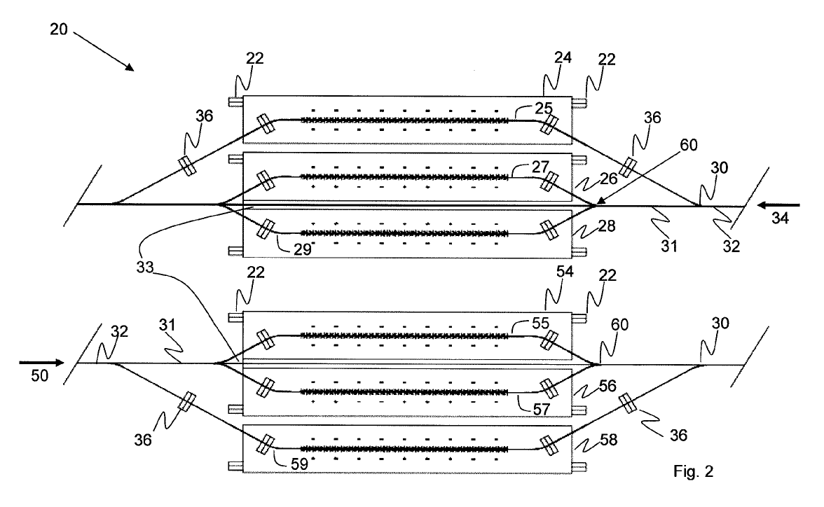

Referring to FIG. 2, a freight transfer yard configuration according to the present invention is shown. A compilation of rail tracks 20, as shown, has a buffer system allowing uninterrupted rail operation into and out of a freight transfer yard. Two buffer systems with three rails per set are shown. Each buffer system services one incoming rail 34 or 50. Each incoming rail 34 and 50 is unidirectional, as shown by corresponding arrows for rails 34 and 50. The number of rail lines required for a buffer system, shown are three rail lines 25, 27, and 29 for rail 34 of FIG. 2 and 55, 57, and 59 for rail 50 is determined based on the amount of time required for freight to load or unload from each rail line as well as the amount of time required between the arrival of trains coming into the freight transfer yard. For example, if trains are allowed to enter the freight transfer yard at a minimum of every 6 minutes, required for safe spacing between trains, while loading and unloading an entire train requires 18 minutes, then at least a buffer of three lines is required to ensure a continuous rail operation in and out of the freight transfer yard. The following function provides a mathematical operation for determining the number of lanes required in each buffer system according to the present invention:

$$\begin{matrix}Number of lanes \\ required in \\ each buffer\end{matrix} = \{ \begin{matrix}\frac{Max\_load \_time}{Min\_train \_time} , \\ If INT ( \frac{Max\_load \_time}{Min\_train \_time} ) = ( \frac{Max\_load \_time}{Min\_train \_time} ) \\ \frac{Max\_load \_time}{Min\_train \_time} + 1 , \\ If INT ( \frac{Max\_load \_time}{Min\_train \_time} ) \neq ( \frac{( Max\_load \_time}{Min\_train \_time} )\end{matrix} \qquad ( 1 )$$

wherein, Max_load_time refers to the maximum amount of time required to load and unload an entire train, 18 minutes in the above example, and Min_train_time refers to the minimum amount of time between incoming trains for safe operations, 6 minutes for the above example. The mathematical operator “INT” provides the integer value of a number. For example, INT(6.8)=6, also, INT(6.0)=6. According to the above example, the top portion of the mathematical function (1) is used to determine the number of lanes. This is because, according to the above example,

$$\frac{Max\_load \_time}{Min\_train \_time} = 3.0 and INT ( 3.0 ) = 3.0 .$$

However, if in the above example, the Min_train_time was 5.99 minutes instead of 6 minutes, the ratio of

$$\frac{Max\_load \_time}{Min\_train \_time}$$

would be 3.005 instead of 3. In this case, the bottom portion of the mathematical function is applicable. This is because,

$$\frac{Max\_load \_time}{Min\_train \_time} = 3.005$$

and INT(3.005)≠3.005, since INT(3.005)=3. Therefore, the number of lanes required in the buffer would be INT(3.005)+1=4.

Also shown in FIG. 2 are defined lanes within which individual train lines are positioned. For example, for rail 34, lanes 24, 26, and 28 include lines 25, 27, and 29 respectively. Similarly, for rail 50, lanes 54, 56, and 58 include lines 55, 57, and 59, respectively. Truck access 22 and truck overpass 36 are provided to service the lanes. Truck access 22 allows trucks to enter the lanes, while truck overpass 36 allows trucks to cross over the rail lines.

Although the figures of the instant application are in connection with the detailed discussion provided for a fright transfer yard, where freight is transferred from one train car to another or from a train car to a truck trailer and vice versa, much of the discussion provided below also applies to freight transfer facilities at manufacturing sites where freight is unloaded from trucks and train cars to be used at these facilities. The freight transfer yard is created by building buffer systems around existing rail lines. For example, rail lines 32 in both top and bottom portions of FIG. 2 are existing rail tracks in use without incorporation of the freight transfer yard. Track switches 30 and 60 switch rail traffic from exiting rail lines 32 to rail lines 25, 27, 29, 55, 57, and 59 and from these track lines back to exiting rail lines 32. Track switches 30 split the rail lines from the existing line 32 to intermediate lines 31 and buffer lines 25 and 59. Track switches 60 split the intermediate line 31 to buffer lines 26, 29, 55, 57, and through-pass lines 33. If the train is not scheduled to stop at the freight transfer yard, by properly positioning track switches 30 and 60, the train is allowed to pass through the freight transfer yard without entering any of the buffer lines.

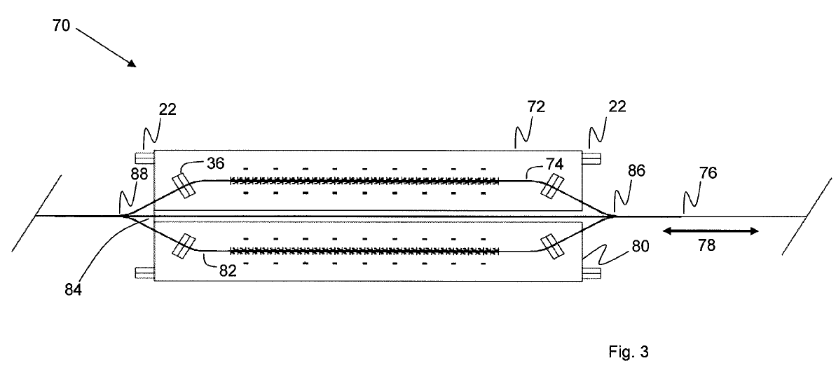

Referring to FIG. 3, a bidirectional rail system 70 is shown. Similar to what was shown in FIG. 2 lanes 72 and 80 include track lines 74 and 82. Existing rail line 76 is split into track lines 74, 82, by track switch 86 and through-pass track line 84. Similarly track lines 74, 82, and through-pass track line 84 converge back to rail line 76 by way of track switch 88. A similar discussion, provided above regarding the required number of lanes in each buffer system to produce a continuous rail operation, also holds true with regards to the bidirectional system 70 shown in FIG. 3.

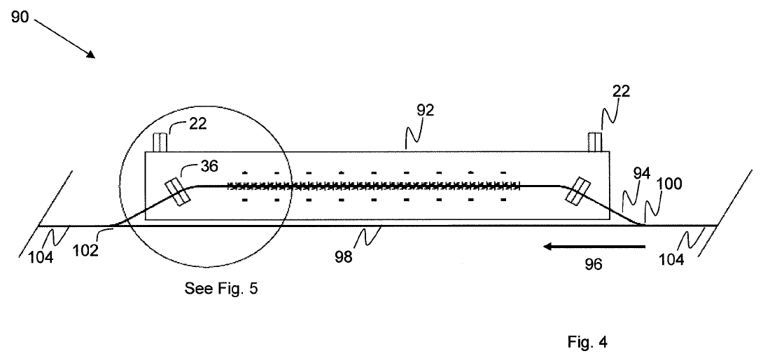

Referring to FIG. 4, a single lane and through-pass rail system 90 is shown. As before, for the unidirectional train traffic shown by the direction of arrow 96, track switch 100 is used to switch train traffic on existing track 104 to track line 94 within lane 92 and through-pass track line 98. Track switch 102 is used to switch between track line 94 and through-pass line 98 back to existing track 104. In this case and as in all of the above cases, through-pass line 98 can be unaltered and part of the existing track 104, or alternatively, can be reconstructed to allow space for additional equipment.

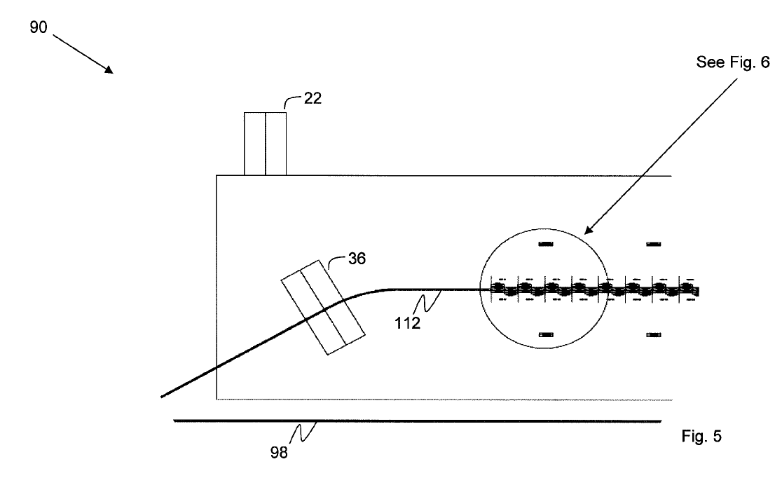

Referring to FIG. 5 a detailed view of the lane and through-pass rail system 90 is shown. Shown are through-pass 98 (possibly part of the existing track) and yard exit rail 112. When a train approaches the freight transfer yard, and the train is scheduled for loading or unloading freight, the track switch, as shown in FIG. 4, places the train in a lane 92 and after the train has been loaded or unloaded, the train exists the freight transfer yard by continuing on yard exit rail 112. Also, as mentioned before, trucks which are used to carry freight away from the train or to the train enter the lane via truck access 22 and are allowed to be positioned on one side of yard exit rail 112, or trucks are allowed to use the overpass 36 so that they can be positioned on the other side of yard exit rail 112. Exact position of trucks will become clear shortly.

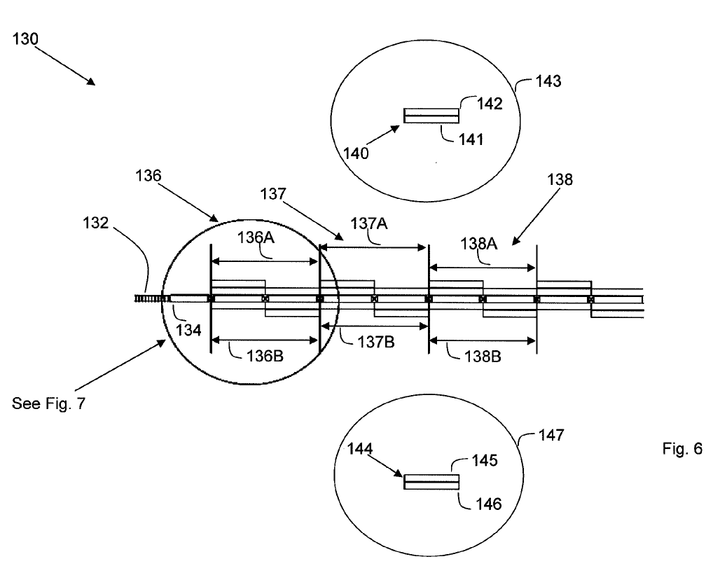

Referring to FIG. 6, a detailed view of a series of load and unload zones 130 is shown. Load/unload zones are situated in lanes, as shown in previous figures. Shown in FIG. 6 is track line 132 and locomotive 134 having cars stopped at load/unload zones 136, 137, and 138. Each zone is divided into two halves intended for near simultaneous loading and unloading as will become clear shortly. The halves are identified by letters “A” and “B.” For example, loading/unloading zone 136 has subzones 136A and 136B.

Also shown are Intermediate Storage Systems 140 and 144. Each intermediate storage system has 2 conveyors able to receive and store freight from a load/unload zone. For example, system 140 has storage conveyors 141 and 142, while system 144 has conveyors 145 and 146. These storage conveyors are used as part of storage or staging areas 143 and 147 for freight containers that are scheduled to have layovers. In other words, if a freight container arrives at the freight transfer yard from a train but is not ready to be moved to the next train or to an outbound truck, the freight will be stored in the storage area until such time that is appropriate for processing the freight. The storage or staging areas are located inside the freight transfer yard away from load and unload zones. More discussion with respect to the storage or staging areas and lane conveyors will be provided below.

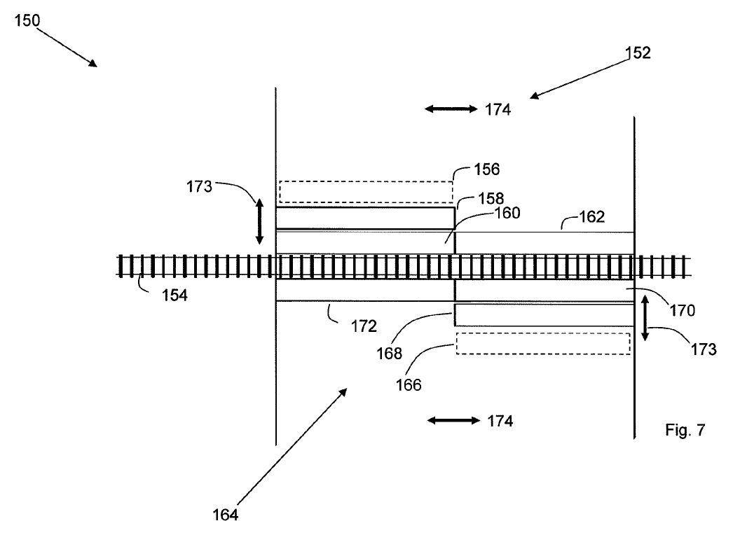

Referring to FIG. 7, a detailed view of a single empty load/unload zone 150 is shown. As mentioned above, each load/unload zone is divided into two parts for the purpose of near simultaneous load/unload operations. These parts are shown in FIG. 7 having reference numerals 152 and 164. Rail line 154 splits the load/unload zone into two parts. These parts have truck parking areas 156 and 166, train load conveyors 160 and 170, train unload conveyors 162 and 172, and truck load/unload conveyors 158 and 168. The train load and unload conveyors as well as truck load/unload conveyors are of the variety which cause freight to be transferred in a perpendicular direction to the rail line 154. For example, for transfer of freight from loaded train cars to trucks, freight can be transferred from trains on to train unload conveyors 172 and 162 in the direction of the arrow designated by reference numeral 173. The freight is then transferred to train load conveyors 160 and 170 in the direction of arrow designated by reference numeral 174. A similar procedure can be repeated for transfer of freight from trucks to trains. This bi-directional movement allows quick transfer of freight from train cars to trucks and vice versa.

The conveyors shown in FIG. 7 are configured so that the conveyors actually contain several small independently powered conveyors which are mounted in fixed rigid frames. These small conveyors can be quickly and easily replaced. The number of these small conveyors in each conveyor assembly allows for the failure of one or more small conveyors and still enables the movement of the freight. Also, the conveyors shown in FIG. 7 are capable of “micro” movements. The micro-movement of the conveyors is described below.

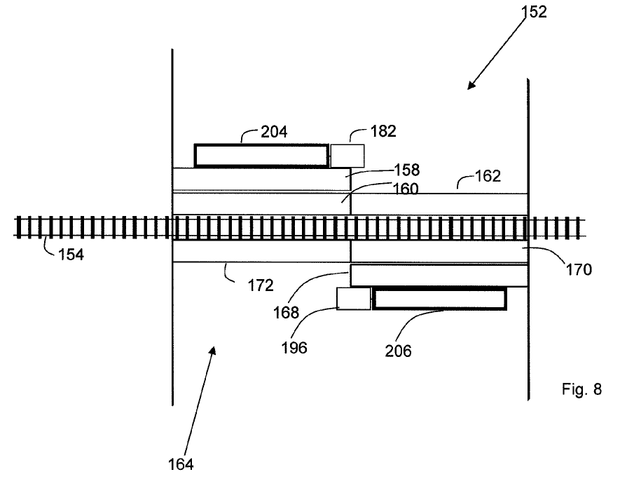

FIG. 8 shows arrival of trucks 182 and 196 at truck parking areas 156 and 166, as shown in FIG. 7. A variety of guiding devices may be used to properly position the trucks with respect to truck load/unload conveyors 158 and 168. These mechanical and electrical devices include but not limited to, proximity switches, infrared positioning systems, and mechanical switches, all of which may include feedbacks using lights or audible alarms. The positioning of trucks 182 and 196 may be based on manual movement of trucks 182 and 196 so that proper alignments between trucks 182 and 196 are achieved with truck load/unload conveyors 158 and 168. Therefore, a driver of the truck is required to position the trucks trailer within a tolerance to guarantee a successful transfer. In addition, a controller in the freight transfer yard communicates positional information to a controller in the truck. It is also envisioned that fixed guides will be mounted in and around the truck stopping area that guide the truck for accurate location which also eliminates a truck from hitting the conveyor during parking.

Alternatively, in order to align trucks 182 and 196 with truck load/unload conveyors 158 and 168, truck load/unload conveyors 158 and 168 are moved with micro-movements in an automated fashion. These micro-movements involve small automated positional adjustments of truck load/unload conveyors 158 and 168 with respect to trucks 182 and 196. In yet another alternative embodiment, the trucks may be moved to achieve proper alignment between the trucks and the load/unload conveyors. These positional adjustments may utilize series of devices such as proximity sensors to achieve the proper alignment.

In addition to aligning position of conveyors with respect to trucks, positions of truck load/unload conveyors 158 and 168 may also need to be aligned with respect to the truck loads 204 and 206 by additional automated micro-movements of truck load/unload conveyors 158 and 168. This secondary alignment is necessary since truck loads 204 and 206 may be of different sizes. Although it is desirable for truck loads to have a standard size and to occupy the trailer portions of the trucks with minimal unused spaces, these teachings anticipate the need for alignment of truck loads with respect to conveyors.

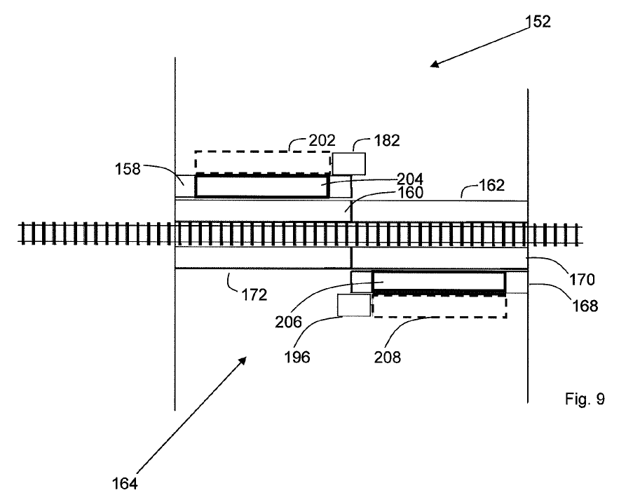

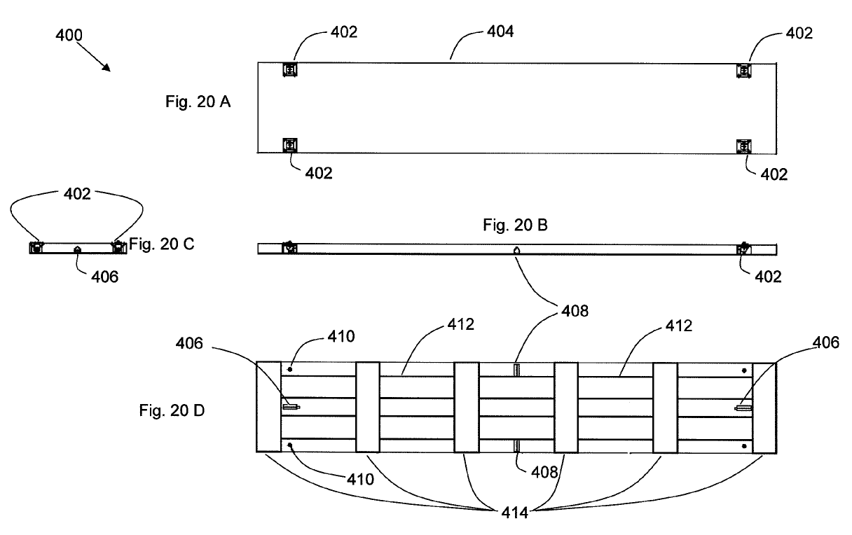

FIG. 9 shows movement of truck loads 204 and 206 from trucks 182 and 196 to truck load/unload conveyors 158 and 168, leaving empty trailers 202 and 208. In order to standardize the interface between freight containers and the apparatuses needed to transfer the freight containers, an adaptor plate is required (see FIGS. 20A-D). Currently, containers carried by trucks and rail systems come in a variety of shapes, and in many cases containers are moved by cranes. However, crane handling of containers is costly, time consuming, labor intensive, requires top lifting, and can damage the freight by rough handling and dropping during transfer. Therefore, according to the current teachings, adaptor plates are needed which are attached to bottom side of the containers. Although a more detailed discussion will be provided below regarding the adaptor plate, a short description of the adaptor plate is provided here. The adaptor plate can be either a retrofit plate attached to the bottom side of a freight container, or the entire freight container can be viewed as the adaptor plate. That is, in some circumstances, attaching a plate to the bottom of an existing container can make the combination a standardized container. Alternatively, the entire container is one piece and constructed so that the interface to truck trailers and train cars is standardized. There may, however, be specialized applications where the adaptor plate is configured differently. For example, in refrigeration applications, a refrigerated container may be considered as an adaptor plate. Conversely, a plate attached to a refrigerated box may be considered as an adaptor plate.

A track-conveyor system which moves the adaptor plate from the truck trailer, to the train car and back again is comprised of several components. These components include rigidly mounted conveyors in a freight transfer yard, conveyors and locate/locking devices mounted on train cars and truck trailers, female locating tooling and wear plates mounted on the bottom of the adaptor plates.

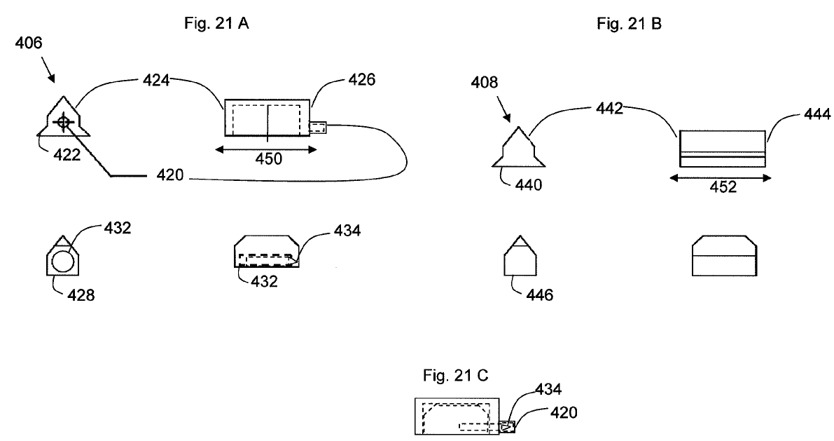

The track-conveyor system is configured such that when a truck trailer is correctly positioned next to truck load/unload conveyors 158 and 168 the track-conveyor system creates a conveyor path for the adaptor plate to move off and on a truck trailer or a train car. Similarly, when a train car is correctly positioned next to train load/unload conveyors 162 and 172 the track-conveyor system creates a conveyor path for the adaptor plate to move off and on a train car. In accordance with one embodiment of the current teachings, movement of truck loads with adaptor plates 204 and 206 from trucks 182 and 196 to truck load/unload conveyors 158 and 168 is accomplished by 1) unlocking adaptor plate from truck bed by releasing locking pins of female locating tooling with locking pin receiver (see FIG. 21A) raise the truck conveyors so that transfer wear plates (see FIG. 20D) make contact with truck load/unload conveyors 158 and 168 and, subsequently, lift the adaptor plate off the locating tooling (see FIG. 21D), and 3) activating conveyors on the truck to move the adaptor plate from the truck and on to the load/unload conveyors 158 and 168. As mentioned, a more detailed discussion of the track-conveyor system is provided below.

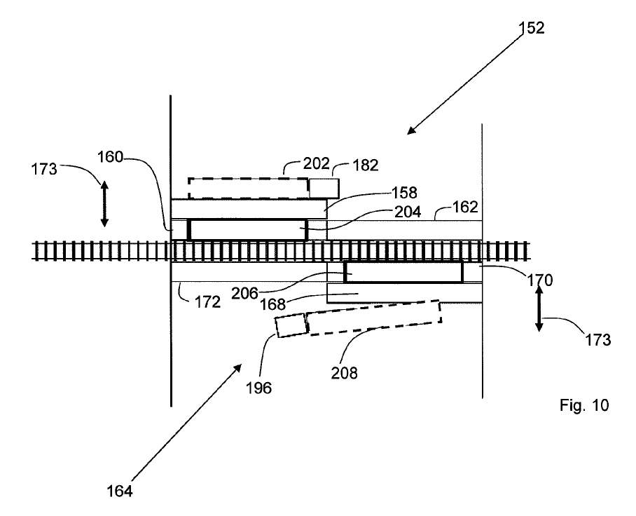

Referring to FIG. 10, truck loads with adaptor plates 204 and 206 are transferred to train load conveyors 160 and 170. The transfer occurs in the direction of arrow designated by arrows 173. Also, shown in FIG. 10 is departure of truck 196 from the freight transfer yard. However, if truck 196 is scheduled to receive an adaptor plate, which is being off loaded from a train car, for example, it would remain in position 166 until the transfer of the adaptor plate occurred.

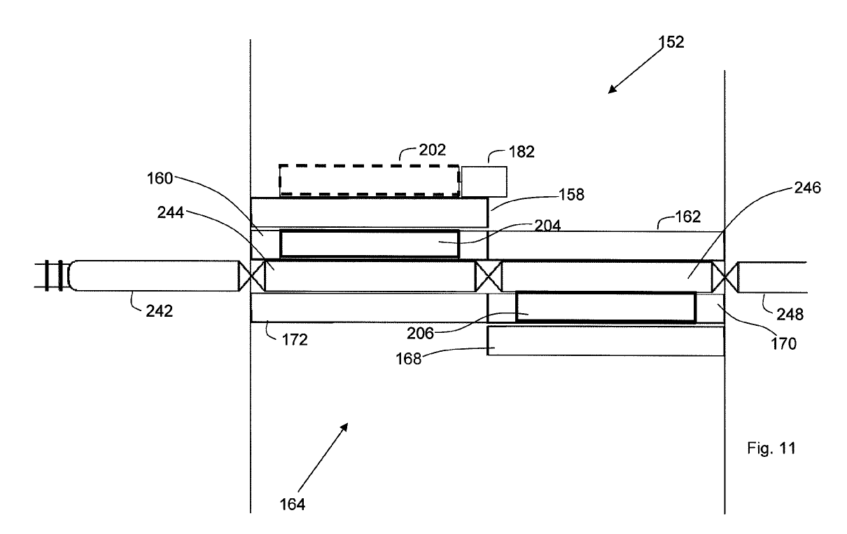

Referring to FIG. 11, arrival of train cars 244, 246, and 248 is shown. The train, which is comprised of a locomotive and a plurality of train cars stops within a certain tolerance, e.g., ±2 feet. The truck loads with adaptor plates 204 and 206, having fright loaded on them, are on train load conveyors 160 and 170. Subsequently, the positions of truck loads with adaptor plates 204 and 206, and hence the adaptor plates, are linearly adjusted to account for the tolerance in the stopping position of the train and any “play” in the connectivity between the cars. Connectivity between train cars can affect the accuracy of the required linear alignment. For example, if the connectivity between cars is of the kind which allows excessive movement between train cars, the alignment procedure must account for such movements. The unwanted movement, disadvantageously, could accumulate so that the position of some cars with respect to their respective conveyors is uncorrectable by linear alignment of the adaptor plate with respect to the train cars. Therefore, another specialized type of coupling between train cars may be implemented to prevent excessive movement (“play”) between the cars. More on the above of specialized coupling will be provided below.

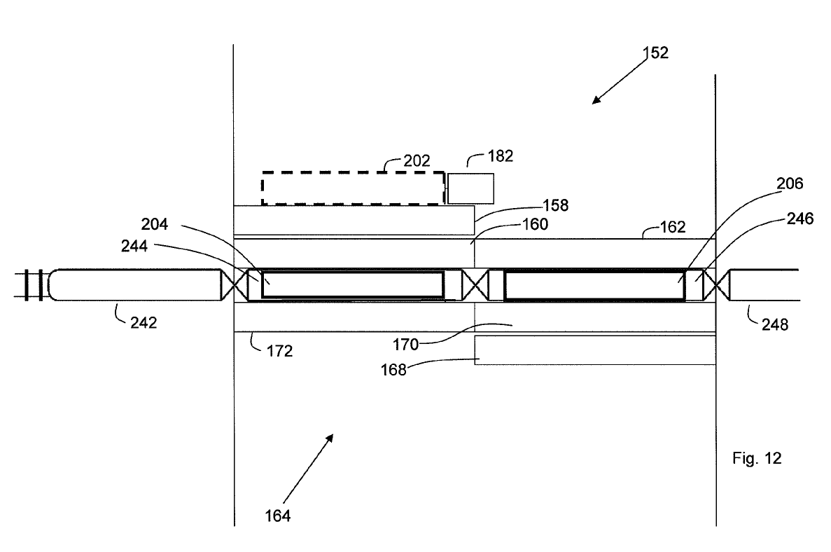

Referring to FIG. 12, truck loads with adaptor plates 204 and 206 are now on train cars 244 and 246, respectively. The movements of truck loads with adaptor plates 204 and 206 onto the train cars 244 and 246 are based on a similar procedure, however, stepped through in a reverse order, as described above with respect to transfer of truck loads out of the trucks. Train load conveyors 160 and 170 comprise lift mechanisms to lift and reposition truck loads with adaptor plates 204 and 206, and hence adaptor plates, so that the adaptor plates are vertically aligned with train cars 244 and 246. Once the adaptor plates are vertically aligned, train load conveyors 160 and 170 transfer truck loads with adaptor plates 204 and 206 into train cars 244 and 246. More detail on the transfer of freight from conveyors to train cars and vice versa will be provided, below.

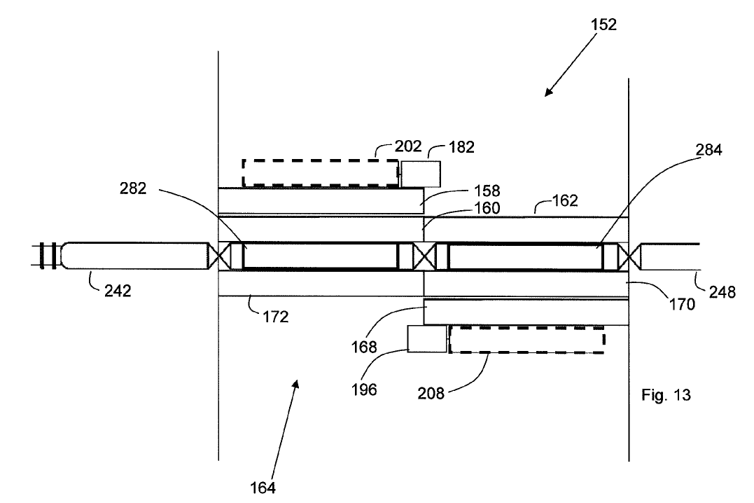

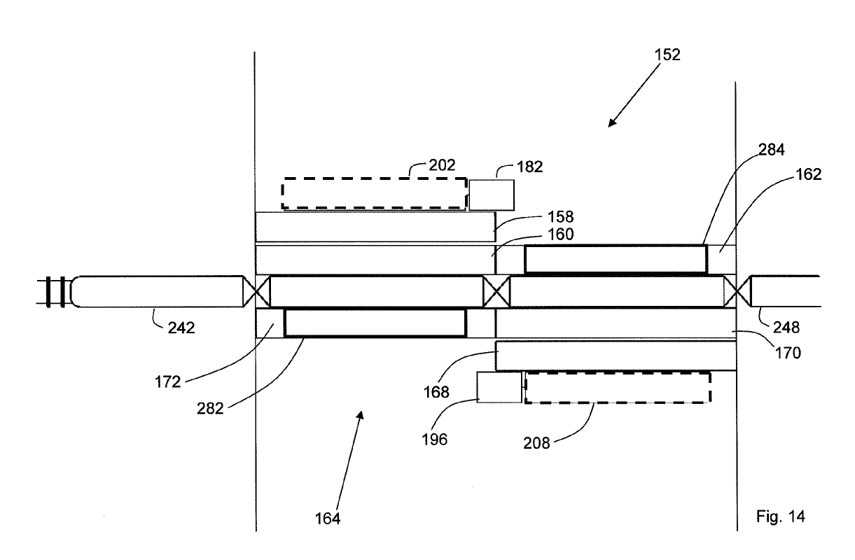

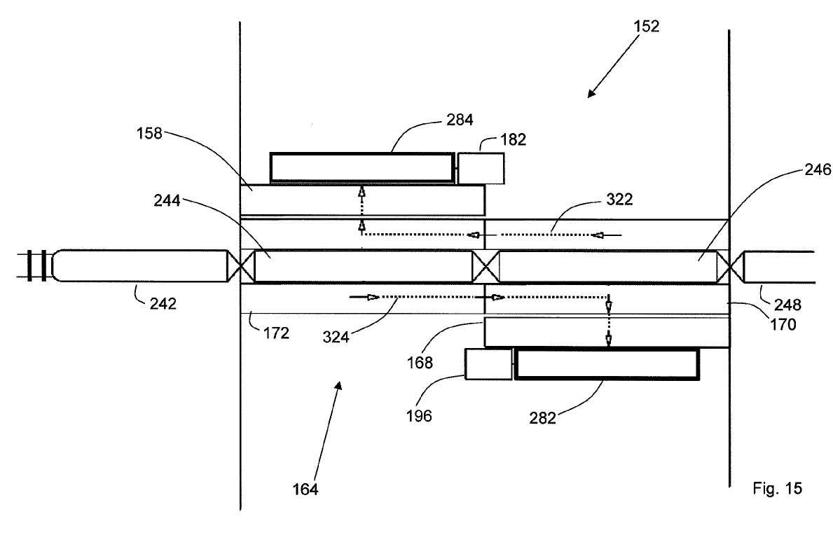

Referring to FIG. 13, a loaded train is shown to have arrived at the freight transfer yard, waiting to be unloaded. Train loads with adaptor plates 282 and 284 are in train cars adjacent to train unload conveyors 162 and 172. Also shown in FIG. 13 are trucks 182 and 196 with empty trailers 202 and 208. FIG. 14 shows transfer of train loads with adaptor plates 282 and 284 to unload conveyors 172 and 162, respectively. FIG. 15 shows transfer of train loads with adaptor plates 282 and 284 from train unload conveyors 172 and 162 to truck load/unload conveyors 168 and 158, respectively. The transfers are accomplished in the path shown by the dotted lines having reference numerals 324 and 322, respectively.

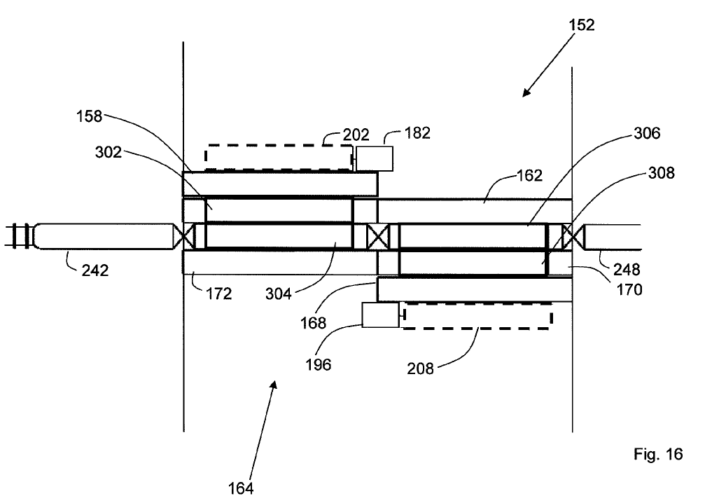

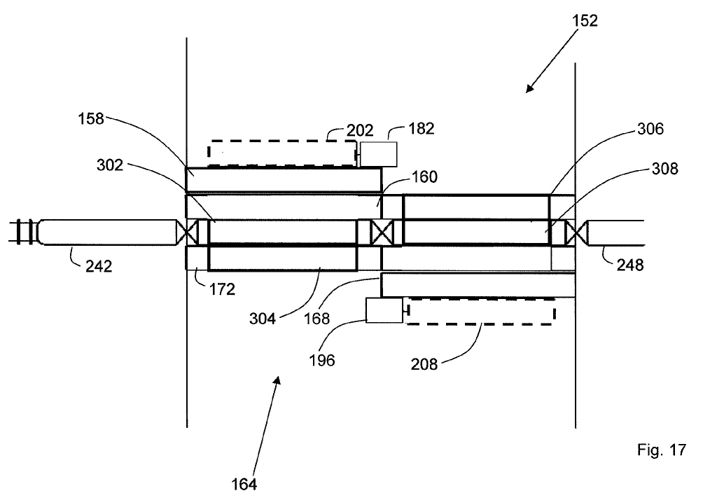

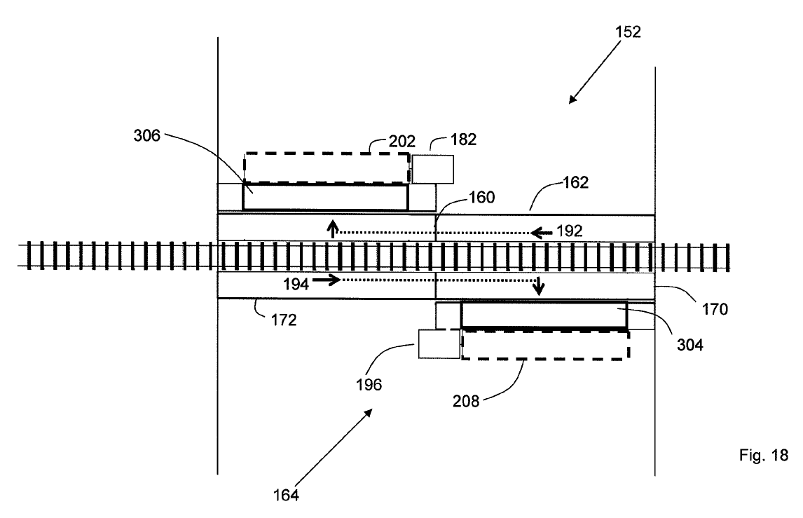

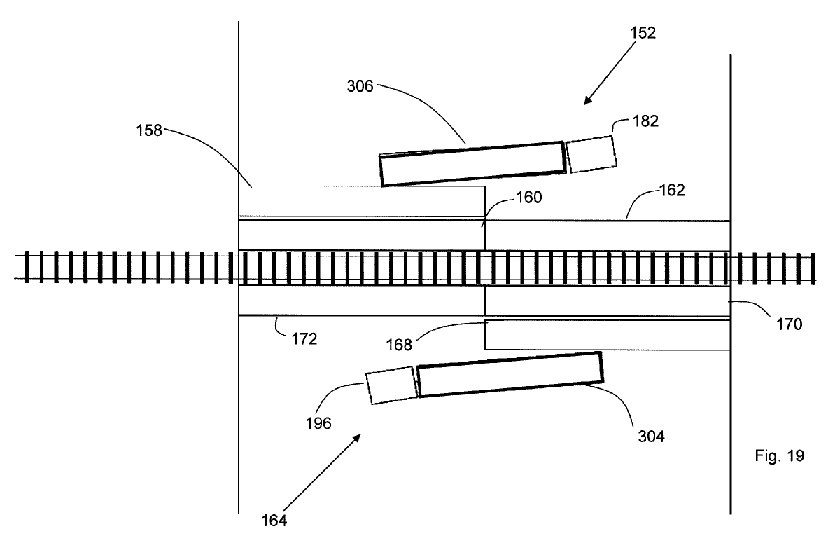

FIG. 16 shows a situation where a loaded train has arrived at the freight transfer yard. Train loads with adaptor plates 304 and 306 are scheduled to be unloaded, while truck loads with adaptor plates 302 and 308, positioned on train load conveyors 160 and 170, are scheduled to be loaded on to the train cars. Accordingly, train loads with adaptor plates 304 and 306 are transferred to train unload conveyors 172 and 162, while truck loads with adaptor plates 302 and 308 are transferred on to train cars. This operation is shown in FIG. 17. As described above, train loads with adaptor plates 304 and 306 transfer from train unload conveyors 172 and 162 to truck load/unload conveyors 168 and 158 before the train loads are transferred to the truck, according to path 194 and 192 shown in FIG. 18. Finally, as indicated in FIG. 19, trucks 196 and 182 carrying train loads with adaptor plates 304 and 306 depart the freight transfer yard, as indicated in FIG. 19.

Exemplary and additional descriptions of several components and systems, according to the current teachings, are provided below. These include the adaptor plate, the train, the train car, the train car coupler, the locking mechanism the truck trailer, a booking system, and docks.

FIGS. 20A-D show one embodiment of the adaptor plate 400. As mentioned above, the adaptor plate 400 is either a plate that can be attached to a standard freight container or a new standardized freight container having the features of the plate integrated as part of the freight container. Therefore, the adaptor plate is collectively defined as a special interface to a freight container with specialized devices attached thereto.

FIG. 20A shows the top view of adaptor plate 400 as a plate 404 that attaches to the bottom of a container. The adaptor plates are allowed to be stacked on top of each other by four stacking pin assemblies 402, located in each corner of plate 404. More on the stacking pin assembly 402 will be provided below.

FIG. 20B shows a side view of adaptor plate 400 revealing female locating tooling 408. FIG. 20C shows an end view of adaptor plate 400 revealing female locating tooling with locking pin receiver 406. Both are utilized to properly locate adaptor plate 400 with respect to the train car or truck trailer. Female locating tooling with locking pin receiver 406 facilitates the locking of the adaptor plate with respect to the train car or truck trailer. FIG. 20D shows a bottom view of adaptor plate 400. Stacker pin holes 410 are located at each corner corresponding to each stacker pin assembly 402. Two types of wear plates 412, 414 are shown in FIG. 20D. Transfer wear plates 414 are designed to wear during transfer of adaptor plate 400 from truck trailers or train cars to conveyors. Position adjustment wear plates 412 are designed to wear while positioning adaptor plate with respect to the train cars or truck trailers. Both wear plates 412, 414 are designed to prevent excessive wear on all contact surfaces, as well as providing convenient paths for adaptor plate 400 to move with respect to the track-conveyor system.

Other adaptor plates are envisioned by the inventors of the instant application. These include: box style which is similar to an existing semi-truck box trailer without the under carriage, bulk carriers for carrying bulk shipment of various loads, liquid carriers for carrying tanks, aggregate carriers for carrying a variety of aggregates including mining loads or crops, refrigerated carriers, environmentally hazardous carriers wherein additional safety measures are required, auto-carriers, and passenger carriers wherein the freight are capable of receiving large number of passengers or receive a mobile home.

The adaptor plate's overall footprint will be based on what freight carriers that will be used to transport the adaptor plates and the freights loaded thereon. For example, an adaptor plate designed for freight moved on the highway will be sized to fit on eighteen-wheel semi-truck trailers. Alternatively, some adaptor plates may remain with only the train portion of the freight transfer system. The footprint of train-only adaptor plates may be as large as allowed by the restrictions of the train system. In both cases, the equipment in the freight transfer yard are configured such that any adaptor plate can be transported, positioned, and locked on the same equipment. Similarly, the locating and locking features of the adaptor plates are configured to allow the adaptor plates to be transported, positioned, and locked by same equipment.

The structural integrity of adaptor plates is based on the load carrying capacity. A color-coding scheme is envisioned whereby maximum load carrying capacity of the adaptor plates is readily identifiable based on the following color-coding schedule: maximum load of 20,000 lbs to be green; maximum load of 30,000 lbs to be yellow; and maximum load of 40,000 lbs to be red. The foregoing schedule is for exemplary purposes only, and it should not be considered as limiting the weight carrying capacity or the color-coding scheme.

The adaptor plate is envisioned to be mechanical in nature without having any power devices attached thereto for the purposes of interfacing to the track-conveyor system. However, a powered adaptor plate could be utilized for transferring freight, with types of power connections well known in the art. Conversely, self containing power generating devices can be utilized. Additionally, well known lifting features for lifting operations by a forklift or a crane may be integrated with the adaptor plate to accommodate movement of the adaptor plate by such devices. For example, lifting by a crane may require features designed into the top of the adaptor plate.

Additionally, features for transferring, locating, and locking of the adaptor plate to a train car or truck trailer are envisioned to be provided at the bottom of the adaptor plate. These features are shown in FIGS. 20B-D and discussed above. The locking features, e.g., female locating tooling with locking pin receiver 406 and female locating tooling 408, are located at the outermost areas of the minimum sized adaptor plate to allow for maximum mechanical advantage. Identical provisions for conveyor contacts or wear plates, e.g., transfer wear plates 414 or position adjustment wear plate 412, located on the bottom of the adaptor plates are provided for uniformity in adaptor plate interface. The wear plates are fabricated from material that eliminates premature wear failure of either the wear plate or the conveyors. Further, all contact surfaces on adaptor plates are to be designed to be easily replaceable.

As shown in FIGS. 20B-D, two different types of locating tooling sets are provided. These are female locating tooling with locking pin receiver 406 and female locating tooling 408, both showing female and male portions of the tooling. These locating tooling are shaped similar to an inverted “V” and are provided at the bottom of adaptor plate 400 in the farthest most locations front to back and side to side, see FIG. 20D. The adaptor plate female locating tooling mates with the inverted male tooling on the train car and truck trailer to assist in positively locating the adaptor plate. FIGS. 21A and 21B show examples of female locating tooling with locking pin receiver 406 and female locating tooling 408 and the matching male inverted “V” tooling on the train car and truck trailer. The top portion of FIG. 21A shows front and side views of female locating tooling with locking pin receiver 406. Female locating tooling with locking pin receiver 406 is a hollow body with hole 420 placed on one or both sides 424 and 426 so that a locking pin may be placed through the holes 420 for the purpose of receiving an actuateable pin which is part of a matching semi-solid male inverted “V” tooling 428, shown in the bottom portion of FIG. 21A. Female locating tooling with locking pin receiver 406 is mounted inside a cavity located at the bottom side of the adaptor plate such that base 422 is flush with the bottom side of the adaptor plate. Matching semi-solid male inverted “V” tooling 428 affixed to the train car and truck trailer is configured to align and fit inside the hollow portion of female locating tooling with locking pin receiver 406. Solenoid pin actuator 432 actuates pin 434 inside hole 420 to lock the locate tooling in place once the male and female locating tools are aligned. A more detailed description of the interface between the male and female locating tooling is provided, immediately below.

When the adaptor plate is lowered on to the bottom interior portion of train car or truck trailer, male inverted “V” tooling 428 fits inside female locating tooling with locking pin receiver 406. Due to matching inverted “V” shapes of the male and female locating tooling as well as the width of base 422, a considerable amount of error in positioning the adaptor plate over the bottom interior portion of a train car or a truck trailer is tolerable. The inverted “V” shape of the male and female locating tooling are configured such that as long as tip of male inverted “V” tooling 428 is aligned with any part of base 422 of female locating tooling with locking pin receiver 406, contact between the male and female locating tooling correctly aligns the adaptor plate against the bottom interior portion of the train car or the truck trailer. During the initial positioning of the male and female locating tooling, solenoid pin actuator 432 retains pin 434 in a retracted position. Once the adaptor plate has been lowered on to the bottom interior portion of the train car or the truck trailer, solenoid pin actuator 432 energizes causing pin 434 to move from the retracted position to an extended position inside hole 420 of female locating tooling with locking pin receiver 406, as shown in FIG. 21C. Pin 434 locks male inverted “V” tooling 428 against female locating tooling with locking pin receiver 406.

FIG. 21B shows front and side views of female locating tooling 408. Female locating tooling 408 is also a hollow body with two sides 442 and 444. Female locating tooling 408 is mounted inside a cavity on the bottom side of the adaptor plate such that base 440 is flush with the bottom surface of the adaptor plate. FIG. 21B also shows a matching male solid location tooling 446. The tooling, shown in FIGS. 21A-B, are positioned perpendicular to each other, as shown in FIG. 20D. That is, the longitudinal axis 450 of female locating tooling with locking pin receiver 406, see FIG. 21A, is perpendicular to the longitudinal axis 452 of female locating tooling 408, see FIG. 21B. The combination of the tooling shown in FIGS. 21A-B ensures a stable connection between the adaptor plate and the truck trailer and/or train car.

Female locating tooling with locking pin receiver 406 and female locating tooling 408 are designed to be mechanically mounted onto the bottom side of an adaptor plate and easily replaceable. Similarly, the mating tooling mechanically mounted onto the bottom portion of train cars and truck trailers are designed to be quickly and easily replaceable.

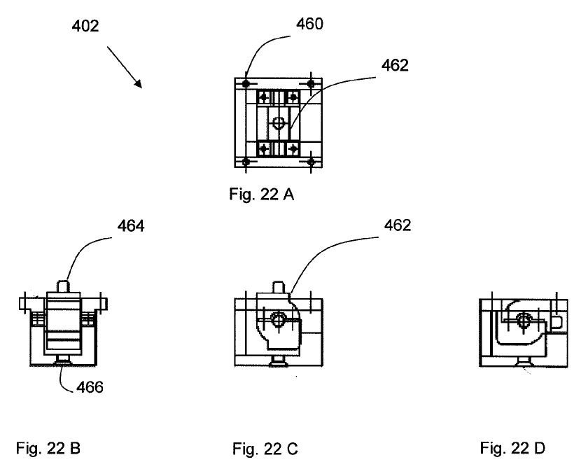

Additionally, adaptor plates are configured to have stacking features in the outer most corners to allow stacking of the adaptor plates. FIG. 20A shows stacking pin assemblies 402 located at each corner of the adaptor plate. FIGS. 22A-D show details of the exemplified stacking pin assemblies 402. FIG. 22A is the top view of stacking pin assembly showing pin assembly 462. The stacking feature is designed to be foldable so that when not in use pin 464 will not protrude out. The folding feature of the stacking pin assembly 402 is shown in FIGS. 22C-D. Pin 464 interfaces with recessed cavity 466 to allow stacking of adaptor plate on top of each other. Pin assembly 462 may be spring loaded, normally held in the folded position (see FIG. 22D), and equipped with an automatic release mechanism, well known in the art, which causes the release of pin assembly in the vertical position (see FIG. 22C) when the adaptor plates are being stacked. The stacking of the adaptor plates is usually accomplished when the adaptor plates are disengaged from freight containers or other freight and/or freight mounting devices. In an alternate embodiment, where the adaptor plates are integrated with freight containers, a similar stacking pin assembly can be utilized to stack containers on top of each other. When no freight is on the adaptor plates they may be stacked for return shipments. In cases where additional space between adaptor plates is required, longer stacking pins can be incorporated.

Each adaptor plate is configured to have a unique identification (ID) number. The ID number is intended to identify information related to the adaptor plate. The following are examples of information that the ID may be tied to: the manufacturer, owner, date commissioned, style, and weight capacity. The identification number is permanently stamped into the steel structure of the adaptor plate. Also, the identification number is painted in large easily visible numbers on the adaptor plate on one or multiple sides.

The adaptor plate is configured to have a Radio Frequency Identification (RFID) tag, permanently recessed into both sides of every adaptor plate. The tag stores an identification number which is read by RFID reader located in various locations. These locations include along the tracks to allow the booking/monitoring system to keep track of the shipments. The specific owner of the adaptor plate is identified by the identification number. Further, the information about the owner of each adaptor plate is stored in a data management system and may be used as a tool for billing. In one embodiment, even if the owner of the adaptor plate is unaware of how an adaptor plate is being used, the owner receives a commission for each time the adaptor plate is used.

In order to prevent a premature failure of a car coupling, the current teachings include a method to determine the distance between each car to verify the distance. This train car spacing monitoring scheme will be mounted on the train cars and interfaces to the train computer system.

According to the current teachings, the train includes a locomotive with a series of specialized cars attached thereto. It is intended for the train cars to be semi-permanently attached to the train. However, in circumstances where additional cars are needed for transferring freight, the cars are added or removed at the end of the train. The train cars are attached to each other by a unique coupling system. The unique coupling system is required to minimize the amount of “play” between train cars and thereby minimize accumulation of positional error.

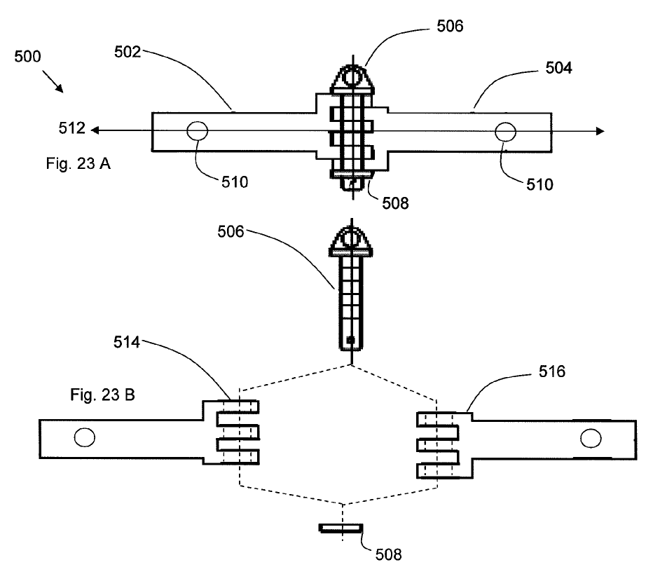

FIGS. 23A and 23B show an example of the unique coupling system 500. Rear coupling 502 is attached to one train car (not shown), and front coupling 504 is attached to another train car (not shown). Pivot holes 510 allow the train cars to pivot with respect to the longitudinal axis 512 of coupling system 500. This pivoting action is required as the train cars move about a curved surface. Pin 506 travels through holes 514, symmetrically located in fork tongs 516. Pin 506 is then secured by a locking washer 508 or by other components well known in the art.

While in a stopped position, the locomotive is intended to provide power in the form of electricity to train the cars for use by powered features on the cars. Also, each locomotive has a controller on board which controls and communicates with train cars and a freight transfer yard controller.

A train car, in accordance with these teachings, receives and locks an adaptor plate. The length of the car should accommodate the maximum length of an adaptor plate, while the width is that of a standard train car. The foregoing and forthcoming features of the train cars are intended to be modular for simplicity of mounting and duplicity. The train car's devices are to provide functional feedback to the control system onboard the train locomotive as part of failure detection and avoidance schemes. Further, the features of the train cars are intended to have simple mounting hardware, quick disconnect features for all power and communication connections, as well as redundancy in case of critical areas.

A controller, located in the locomotive, controls all freight transfer functions on the train. The controller also communicates with the freight transfer yard controller to identify which adaptor plates are to be offloaded or which cars are to receive adaptor plates. When the train has come to a stop at a freight transfer yard, the locomotive controller sends signals to each car's devices to coordinate the offloading of the car. The first signal is to stabilize the car by locking the suspension system of the car. In return, the train car provides a feedback signal to confirm the suspension is locked. A discussion of steps involved in locking of the suspension is provided, below. Once the locomotive controller receives the suspension locking feedback signal, the locomotive controller activates locking devices to unlock the adaptor plate. Similarly, a feedback signal from the devices to the controller confirms unlocking operation of the adaptor plate. Next, the locomotive controller signals the track-conveyor system on the train car to raise the adaptor plate off of the location tooling mounted on the cars, in order to achieve the same height as the conveyors adjacent to the car in the freight transfer yard. As the adaptor plate is raised by the conveyor it also clears the locating tooling sets. Similarly, a feedback signal is provided when the lifting operation is completed. It will be appreciated that while the train is moving all adaptor plates are resting on the fixed wear plates that are part of the track-conveyor system and not on the conveyors. Next the controller provides a signal to the train car to initiate transfer of freight. This signal activates the conveyors on the train car. Simultaneously, conveyors adjacent to the car activate to receive the adaptor plate from the train car conveyors. Once the adaptor plate is successfully transferred to the conveyors adjacent to the train cars, confirmation signals of successful transfer are sent from the train car conveyor and freight transfer yard conveyors to the controller. This foregoing process is essentially reversed for loading an adaptor plate to a car. While each train car load/unload functions are controlled separately by the locomotive controller, all of the adaptor plates scheduled to be unloaded or loaded are unloaded or loaded nearly simultaneously. Similarly, in the freight transfer yard, while each conveyor in the track-conveyor system is controlled independently by the freight transfer yard's controller, movements of all the adaptor plates from one zone to another zone are nearly simultaneous. In order to accomplish this nearly simultaneous movement of the adaptor plates, the freight transfer yard controller directs both the locomotive controller and truck controllers. The concept of zones will be discussed later.

The above-mentioned track-conveyor system comprises a series of small conveyors and devices designed to move an adaptor plate on or off of a train car or a truck. In addition, conveyors are installed on the cars and truck trailers to facilitate the moves. These conveyors are mounted perpendicular to the length of the train car or truck trailer and in parallel along the train tracks. The conveyor locations match that of the wear strips on the bottom of the adaptor plate. All train mounted devices are powered by generators on the trains and all truck mounted devices are powered by the truck generators. The conveyors are individually lifted up and down to engage the adaptor plates.

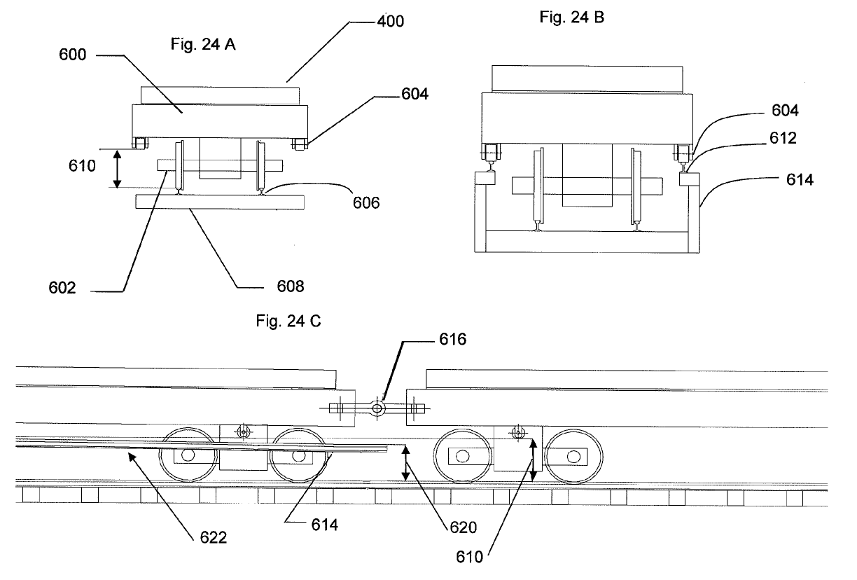

Train car stabilization is required to eliminate any height differences between the conveyor located in the train car and the conveyors in the freight transfer yard. The undesired height difference may be due to suspension. Different methods and devises may be used to stabilize the train car. For example, devices active on the train car may be used to stabilize the train car. Alternatively, devices in the freight transfer yard may be used to stabilize the train car. FIGS. 24A-C show an example of freight transfer yard car stabilization which is a fixed position lift rail device mounted at the freight transfer yard and is utilized to raise each train car to a fixed height as the train enters the yard. Such a fixed position lift rail device is constructed to have stabilization rail 614 mounted on each side of the track. At the entrance to the freight transfer yard stabilization rail 614 gradually slopes up so that by the time each train car is in the yard they are all at the same height. Idler rollers 604 mounted on the bottom of each car frame 600 gradually come in contact with the stabilization rail 614, and thereby lift the car to a predetermined height. Therefore, as the train moves into the yard and into position adjacent the conveyor located in the freight transfer yard the weight of the cars all rest on the lift rail thereby positioning all of the cars at the same height as the freight transfer yard conveyors. A significant dimension in configuring stabilization rail 614 is height 610 between bottom of wheels 602, resting on top of rails 606 which are mounted on railroad ties 608, and bottom of idler rollers 604. Lift rails 612, which are fixed to stabilization rails 614, come in contact with idler rollers 604. In FIG. 24C, two train cars coupled together with coupling device 616 are shown entering the freight transfer yard. The effect of idler rollers 604 riding on lift rails 612 is shown by difference in height of idler rollers 604 in un-lifted position 610 and height 614 of lift rails 612 from top of rails 606. As is abundantly clear by inspecting FIG. 24C, idler rollers make contact with lift rails 612 as the train is entering the freight transfer yard. The entire train car from idler rollers 604 up, including the adaptor plate, is lifted by virtue of upward slope 622 of stabilization rail 614. The resulting lift off of the train's suspension ensures that each train car and the adaptor plate on that train car is at the same height. As the train cars exit the freight transfer yard, a downward slope of stabilization rail 614 causes each train car to lower onto the suspension of the car.

As mentioned above, a new train car coupling device is envisioned to eliminate or minimize relative movement between train cars. It is envisioned that stopping accuracy of the train is required to be within 24 inches of target. Detailed discussion of car coupling and stopping accuracy is forthcoming.

A design goal of the current teachings is to make each car symmetrical with respect to the front and rear of the car. This eliminates the need to orientate the cars during initial train configuration. Further, mechanical features on the leading and trailing edges are required to enable manual linking of two cars together while a maintenance worker is between the two cars during a normal stop at any freight transfer yard.

As mentioned above, a train car coupling device, shown in FIGS. 23A-B, joins the locomotive with the train car and joins cars together. The coupling device will be designed as a semi-permanent device. The specification for the coupling device requires substantial elimination of movement between train cars and between the locomotive and a train car when the locomotive is pulling and/or pushing the cars. Also, the coupling is intended to have the least amount of moving parts, while it should have a heavy duty bearing surface for smooth pivoting between cars during movement of the train around curves. The coupling should also minimize friction and wear at the coupling point. Another design goal is to have the couplings on the front and rear of a car exactly the same to minimize requirements for spare parts. Also, it is desirable that attaching two cars by the way of the coupler should take minimum amount of time. The coupling must be designed to be modular to make replacing wear surfaces simple and possible during a normal transfer stop at any freight transfer yard. Finally, it is envisioned that electrical or communication connections may be mounted to the coupling structure.

A locking mechanism, as seen in FIGS. 21A-B, locks the adaptor plate to the train car or truck trailer, in order to prevent movement of the adaptor plate during transit. The locking mechanism is intended to be universal for both a train car and a truck trailer. The locking mechanism includes up to 4 independent devices that engage the adaptor plate when correctly positioned on the train car or the truck trailer. Each of these independent devices is mounted on the train car or the truck trailer. In order to maintain maximum footprint of the adaptor plate, the locking mechanism engages the adaptor plate from the bottom surface of the adaptor plate. Movement of the locking mechanism, e.g., from lock to unlock positions, is accomplished by a solenoid to lock and a different solenoid to unlock without any spring or automatic return in case of a power loss. Also, each independent locking device has a position feedback system for both the lock and unlock positions.

Although the freight transfer yard is described in the context of the figures in the instant application, further description supplementary to the already described freight transfer yard is provided. The yard, according to the present invention, is divided into 3 main areas, as shown in FIGS. 5 and 6. These are truck access gates 22 (see FIG. 5), load/unload zones 136A and 136B (see FIG. 6), and storage areas 143 and 147 (see FIG. 6). There are three varieties of truck access gates: load entry gates which allow trucks into a freight transfer yard having adaptor plates to unload; pickup entry gates which allow empty trucks into the yard to pickup an adaptor plate with a load; and exit gates which allow loaded or empty trucks to leave the yard. Each gate has an RFID reader. Each RFID reader will read tags on the truck, trailer, and adaptor plate.

A truck having an adaptor plate will be scheduled to be positioned in a zone and the driver is informed which zone the track is scheduled to go to and allowed to enter the yard. Subsequently, the truck's onboard controller informs the driver where to park for the transfer. In contrast, a truck carrying an adaptor plate that is not scheduled for loading is directed to a holding area to wait until such time as the adaptor plate is allowed into the yard. Therefore, only trucks having adaptor plates scheduled to be offloaded or loaded are allowed into the freight transfer yard. In one embodiment according to the current teaching, RFID readers strategically located at each gate collect data regarding trucks, trailers, and adaptor plates.

The second main area of the yard is the train transfer zone 136A and 136B (see FIG. 6). The yard is divided into zones where truck drivers are directed to pickup or drop off adaptor plates. Each zone has a first sub-zone, designated by letter “A,” and a second sub-zone, designated by letter “B,” each of which is comprised of a minimum of 3 separate conveyors each. As shown in FIG. 6, for example, a single conveyor 158 and 168 (see FIG. 7) interfaces to each truck trailer to load and unload adaptor plates in the direction perpendicular to the direction of the trucks. Each zone is configured to have a visual display at the track interface point to inform the driver of the correct drop off or pickup location. Further, RFID readers will confirm that the correct truck is at the correct conveyor. Therefore, the conveyor is configured to not allow transfer either on or off if the wrong truck is parked at the truck interface point.

Similarly, in any specific sub-zone a set of two conveyors 160-162 and 170-172 (see FIG. 7) interface to two train cars in a fashion perpendicular to the travel of the train. One conveyor 172 (see FIG. 14) can receive an adaptor plate from the first train car while the other 160 can transfer another adaptor plate to the second train car. On the opposite side of the tracks two conveyors 162 and 170 function in the same manner. However, the conveyor opposite the load conveyor is an unload conveyor and the conveyor opposite the unload conveyor is a load conveyor. This allows every other train car to unload to its left side while the remaining cars unload to the right. In addition, the conveyors that interface to the train cars have additional conveyors that run parallel to the train tracks. These conveyors are used to reposition the adaptor plates so they are in the correct position to transfer to and from the train cars. All conveyors in zones have a roof structure overhead for protection against inclement weather.

The third main area of the freight transfer yard is the storage area 143 or 147, see FIG. 6. During transit adaptor plates may need to switch trains in the freight transfer yard to get to the final yard for delivery to the customer. While the correct train scheduled to pick up the adaptor plate which has separated from the previous train has not arrived at the yard yet, the adapter plate waits in the storage area. A storage area is a set of lane conveyors (141, 142, 145, and 146) capable of accepting adaptor plates that are designated for a layover. The adaptor plates move from a zone to storage via onsite trucks operating inside of the freight transfer yard only. Similarly, the storage area has a roof structure overhead to protect the conveyors from inclement weather.

In addition to the main areas just mentioned, other areas in the freight transfer yard can be set up for the Transportation Security Administration or Homeland Security to inspect any loads or adaptor plates. Freight transfer truck-trailer rigs are informed where to off load the adaptor plates and only that specific location will accept the adaptor plates. Alternatively, a system of conveyors can be used to unload a truck's adaptor plate and automatically route it through security systems and/or manual inspection.

Empty adaptor plates can be stacked on top of each other using the stacking pin shown in FIG. 22. Stacking improves efficiency of returning empty adaptor plates. This stacking feature allows for automatic stacking equipment to stack or unstuck the adaptor plates. Stacking equipment can be located inside the freight transfer yard or in other appropriate locations.

Similar to train cars, a truck trailer is designed to receive and “lock in place” an adaptor plate. A truck & trailer rig is a unit device and never separated except for failure or repair issues. Similarly, train cars which are attached to each other by mechanical couplings are also considered a unit device and the train cars do not need to be separated except for failure or repair issues. Therefore, the mechanical coupling between the truck and the trailer is a semi-permanent design. The trailer will be designed for the largest adaptor plate footprint. Each trailer will have an RFID tag mounted on both sides, in a specific location, to allow automatic identification of the trailer as it enters or leaves a freight transfer yard, a staging yard, or a customer's dock. Also, power for the trailers freight transfer devices comes from the truck.

The system designed according to the current teachings for controlling the bidirectional flow of loads to and from freight transfer yards is a multi-tiered hierarchy system that communicates with the individual devices and is designed with redundancy where required to eliminate system failure. Each part of a control system has redundancy to reduce or eliminate possibility of system crashes, is designed to be modular to allow expansion and upgrades, and is capable of communication with other parts of the system and other controllers.

The first tier of the control system is a booking system controller (hereinafter, referred to as “BSC”) which is the master scheduling system that ties all of the other controllers together. BSC tracks all of the equipment described above which make up the system of the current teachings. These include, locomotives, train cars attached to a locomotive, all trains travel routes and schedules, all trucks travel routes and schedules, adaptor plates anywhere within the system.

BSC allows a customer to control freight shipment parameters such as cost, schedule, weight, product, etc. BSC is accessible to the customer through the internet, wherein the customer is able to enter appropriate freight criteria, including type of shipment, e.g., bulk, material classification, e.g., hazardous or nonhazardous, estimated weight, and other customer-selected shipping parameters, e.g., schedule, cost, etc.

BSC evaluates the customers' requested shipping parameters and compares with the known, or scheduled, empty cars for the route. If availability is detected then a price is calculated for that route and presented to the customer. BSC software offers several solutions showing delivery schedule and cost.

If the customer agrees with the schedule and cost, the customer can book the shipment. The customer selects the solution best suited to its needs and enters in the adaptor plate tracking number on which its freight will be placed into the software. BSC's software confirms the booking and prints out the scheduled path the adaptor plate will take to get to its destination. From this point on, a specific position on a specific train and truck is reserved for this specific adaptor plate. The system automatically schedules the pickup by a truck of the current teachings. The truck picks up the adaptor plate and takes the freight to a freight transfer yard or to a staging area to await arrival of the correct train.

BSC also bills the shipper automatically at the time of booking. Billing adjustments are made as the actual weight of the shipment is obtained at the freight transfer yard. As the truck delivers the adaptor plate to the freight transfer yard, the adaptor plate is weighed. The RFID readers identify the truck, the trailer, and the respective weights and deducted from the total weight to give the actual weight of the adaptor plate and its load.

Special features may be implemented for other billing arrangements but will require password protected software manipulation. Examples of these specialized billing arrangements include receiver billings, COD, and 3rd party billings.

BSC automatically allows for some lost time due to unforeseeable problems. Also, BSC allows the customer to view the progress of their shipment online through a login procedure.

The second tier of the control system is the freight transfer yard controller (hereinafter, referred to as “FTYC”) which controls all of the activities in a particular yard. FTYC allows trucks to enter to drop off or pickup adaptor plates, informs each truck controller which zone to park at, controls the conveyors to move the adaptor plates to and from the trucks and train cars, and communicates with the locomotive controller to inform which cars must be unloaded or loaded.

The third tier of the control system is the vehicle controller which controls all of the functions of a train and a truck. The vehicle controller communicates with the FTYC, turns on and off each individual conveyor on each train car or truck trailer to unload or load a car or trailer, and communicates with the data management controller to identify equipment that is scheduled for maintenance.

Finally, the data management controller stores all of the historical data which is not feasible to store at the local controller level. A log of all equipment used in any particular shipment will be used as a tool for preventative maintenance and is not accessible to the general public.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of transferring freight from a first location to a second location, comprising the steps of:
loading the freight onto a plate at the first location, the plate having an identifier linked to the freight;
monitoring the movement of the plate using the identifier on the loaded plate;
conveying the loaded plate onto a first transportation unit at the first location;
transporting the loaded plate from the first location to an interim location using the first transportation unit;
conveying the loaded plate from the first transportation unit onto a second transportation unit;
transporting the loaded plate from the interim location to the second location using the second transportation unit;
conveying the loaded plate from the second transportation unit at the second location; and
unloading the freight from the plate.

2. The method of claim 1, further comprising the step of scheduling the transfer of freight.

3. The method of claim 2, wherein the step of scheduling the transfer of freight further comprising:
determining a route for the transfer of freight between the first and the second locations; and
reserving the first and second transportation units according to the determined route for the transfer of freight between the first and the second locations.

4. The method of claim 3, further comprising the step of controlling freight transferring parameters.

5. The method of claim 4, wherein the step of controlling freight transferring parameters includes accepting the parameters from a customer, evaluating the parameters, and providing to the customer a price associated with the parameters.

6. The method of claim 5, wherein freight transferring parameters include any of cost, schedule, weight, product, and type of shipment.

7. The method of claim 5, wherein the step of determining the route is based on the freight transferring parameters.

8. The method of claim 1, wherein the step of conveying the loaded plate onto the first transportation unit, further comprising:
aligning locating tools of the loaded plate with locating tools of the first transportation unit, wherein at least one of the locating tools of the loaded plate is equipped with a locking pin;
locking the locating tools of the plate with the locating tools of the first transportation unit; and
transmitting a signal from the loaded plate to a transportation unit controller confirming the step of locking the locating tools of the plate with the locating tools of the first transportation unit.

9. The method of claim 1, wherein the step of conveying the loaded plate from the first transportation unit onto the second transportation unit, further comprising the steps of:
conveying the loaded plate from the first transportation unit to a first conveyor;
conveying the loaded plate from the first transportation unit load/unload conveyor to a second conveyor; and
conveying the loaded plate from the second conveyor to the second transportation unit.

10. The method of claim 9, wherein the step of conveying the loaded plate from the first transportation unit to the first conveyor, further comprising the steps of:
unlocking locating tools of the loaded plate from locating tools of the first transportation unit;
transmitting a signal from the loaded plate to a transportation unit controller confirming the step of unlocking the locating tools of the loaded plate from the locating tools of the first transportation unit; and
activating a conveyor in the first transportation unit to convey the loaded plate from the first transportation unit to the first conveyor.

11. The method of claim 10, wherein the step of activating the conveyor in the first transportation unit, further comprising the step of raising the conveyor in the first transportation unit to a height substantially equal to the first conveyor.

12. The method of claim 10, wherein the step of conveying the loaded plate from the first conveyor to the second conveyor, further comprising the steps of:
conveying the loaded plate in a direction perpendicular to a longitudinal axis of the first transportation unit;
conveying the loaded plate in a direction parallel to the longitudinal axis of the first transportation unit; and
conveying the loaded plate in a direction perpendicular to a longitudinal axis of the second transportation unit.

13. The method of claim 12, wherein the loaded plate can be conveyed in a direction perpendicular to the longitudinal axis of the first transportation unit from both sides of the first transportation unit.

14. The method of claim 1, wherein the step of monitoring the movement of the plate using the identifier on the plate, further comprising the step of reading the identifier on the plate by a plurality of readers located at the first location, interim location, and the second location.

15. A freight transfer system comprising:
a platform for receiving a load from a first transportation unit;
a conveyor on the platform for conveying the load from the first transportation unit on a first side of the platform to a second transportation unit on a second side of the platform;
a plate carrying the load on the conveyor and in the first and the second transportation units, the plate having a readable identifier linked to the load; and
a controller for monitoring the movement of the load using the identifier on the plate.

16. The freight transfer system of claim 15, wherein the plate is configured to be stacked on another plate when the plates are in unloaded states.

17. The freight transfer system of claim 15, wherein the loaded plate is equipped with a top-lifting feature configured for a crane to lift the loaded plate.

18. The freight transfer system of claim 15, wherein the plate includes a radio frequency identification tag permanently attached to the plate, the radio frequency identification tag being readable by a plurality of readers located proximate to the platform.

19. The freight transfer system of claim 15, wherein the identifier is visibly positioned on the plate, the identifier corresponding to a manufacturer, an owner, a date the plate was commissioned, a style, and a weight capacity.

20. The freight transfer system of claim 15, wherein the conveyor, further comprising
a first platform conveyor proximate to the first transportation unit; and
a second platform conveyor proximate to the second transportation unit.

21. The freight transfer system of claim 15, further comprising a first transportation unit conveyor in the first transportation unit and a second transportation unit conveyor in the second transportation unit.

22. The freight transfer system of claim 21, wherein the plate is conveyed from the first transportation unit conveyor to the first platform conveyor and from the first platform conveyor to the second platform conveyor to the second transportation unit conveyor.

23. The freight transfer system of claim 22, wherein the plate is conveyed from the first transportation unit conveyor to the first platform conveyor in a direction perpendicular to the first transportation unit longitudinal axis.

24. The freight transfer system of claim 22, wherein the plate is conveyed from the first platform conveyor to the second platform conveyor in a direction parallel to the first transportation unit longitudinal axis.

25. The freight transfer system of claim 22, wherein the plate is conveyed from the second platform conveyor to the second transportation unit conveyor in a direction perpendicular to the second transportation unit longitudinal axis.

26. The freight transfer system of claim 21, wherein the first transportation unit conveyor is configured to change heights to a height equal to the first platform conveyor.

27. The freight transfer system of claim 21, wherein the second transportation unit conveyor is configured to change heights to a height equal to the second platform conveyor.

28. The freight transfer system of claim 15, further comprising:
a main lane for receiving a plurality of first transportation units; and
a plurality of buffer lanes coupled with the main lane, whereby the plurality of first transportation units received by the main lane diverge to the plurality of buffer lanes, each buffer lane configured to receive at least one first transportation unit.

29. The freight transfer system of claim 28, further comprising a plurality of platforms for receiving loads from each of the first transportation units and a plurality of conveyors on the platforms for conveying the loads to a plurality of second transportation units.

30. The freight transfer system of claim 29, wherein the number of buffer lanes is determined based on time spacing between each of the first transportation units of the plurality received by the main lane and an amount of time required to convey the loads from each first transportation unit to each second transportation unit.

31. The freight transfer system of claim 15, wherein the first transportation unit includes a first transportation unit controller and the second transportation unit includes a second transportation unit controller.

32. The freight transfer system of claim 31, wherein the plate is equipped with aligning and locating tools, wherein at least one of the aligning and locating tools of the plate includes a locking pin,

33. The freight transfer system of claim 32, where each of the first and the second transportation units include locating tools and the aligning and locating tools of each plate are configured to align and lock in place the plate with matching locating tools positioned on the first and the second transportation units.

34. The freight transfer system of claim 33, wherein the plate is configured to transmit signals from the plate to the first and the second transportation unit controllers, the signals corresponding to when the plate has aligned and locked in place with the matching locating tools on the first and the second transportation units.

35. The freight transfer system of claim 32, wherein the first transportation unit controller is configured to activate a first transportation unit conveyor and authorize movement of the first transportation unit when the transmitted signal is successfully received by the first transportation unit controller.

36. The freight transfer system of claim 34, further comprising a platform controller in communication with the first and the second transportation unit controllers.

37. The freight transfer system of claim 15, wherein the controller determines a route for the transfer of freight between a first location and a second location and reserves the first and the second transportation units according to the determined route for the transfer of freight between the first and the second locations.

38. The freight transfer system of claim 37, wherein the controller determines the route based on a plurality of freight transferring parameters which include cost, schedule, weight, product, and type of shipment.
